(19) United States
(12) Patent Application Publication
(10) Pub. No.: US 2012/0265714 A1
(43) Pub. Date: Oct. 18, 2012

(54) System and Method for Cord Ownership Recognition

(76) Inventor: Earl Wilbur Duval, North Reading, MA (US)

(21) Appl. No.: 13/444,966

(22) Filed: Apr. 12, 2012

Related U.S. Application Data
(60) Provisional application No. 61/474,504, filed on Apr. 12, 2011.

(51) Int. Cl. F16B 1/00; G06Q 90/00; B23P 11/00

(52) U.S. Cl. 705/500; 24/630; 411/429; 29/428

(57) ABSTRACT

A system and method for customizing a cord according that is indicative of the owner of the cord. The system and method may further be adapted to organize a cord in a bundle.

### CROSS-REFERENCE TO RELATED APPLICATIONS

This application claims priority under 35 U.S.C. §119 to the following U.S. Provisional Patent Application, which is hereby incorporated by reference in its entirety: U.S. Ser. No. 61/474,504 filed on Apr. 12, 2011.

### COPYRIGHT STATEMENT

A portion of the disclosure of this patent application document contains material that is subject to copyright protection including the drawings. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

The present application relates to fastening means to a cord as a way of identifying ownership of the cord. The application also relates to the organizing or bundling of a cord.

2. Description of the Prior Art

There are cord tagging and labeling devices available in the market, but none are configured to be customizable to reflect the personality, profession, characteristics, philosophy, education, loyalty, and other unique representations of the owner. In addition, the devices available on the market do not present inter-connectable customizable cord marking and/or organizing solutions in a simple unit. The present application seeks to address these concerns.

### SUMMARY OF THE INVENTION

Illustrative embodiments of the present invention shown in the drawings are more fully described in the Detailed Description section. It is to be understood that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a system and method for identifying the ownership of a cord. One illustrative embodiment is a system for attaching a cord identifier to a cord, the system comprising a body having at least two deformable prongs that form a portion of a channel within the body. Additionally, a portion of the outer surface of the body has an identifying mark indicative of or associated with the owner of the cord.

Another embodiment includes a body comprising three detents, wherein two of the detents are configured to receive a portion of a cord and the third detent configured to receive a decorative accessory.

In another embodiment, an identifier is comprised of a plurality of detents configured to turn an electronic cord into a decorative necklace or bracelet.

These and other embodiments are described in more detail herein.

### BRIEF DESCRIPTION OF THE DRAWINGS

FIGS. 1A-1B illustrate perspective views of the top and bottom of a cord identifier.

FIG. 1C illustrates a side elevational view of a cord identifier.

FIG. 1D illustrates a side perspective view of a cord identifier, showing a cord identification clip attached to a cord and interconnected with a second cord identifier.

FIG. 1E illustrates a side view of a cord identifiers having flat customizable surfaces.

FIG. 1F illustrates a top view of a cord identifiers having flat customizable surfaces.

FIG. 1G illustrates variations of uni-body cord identifiers ranging from having a single channel or cavity to a plurality of channels or cavities configured to receive a portion of a cord.

FIGS. 2A-2G illustrate a plurality of cord identifiers.

FIG. 3 illustrates a cord identifier configured to receive a decorative accessory.

FIG. 4 illustrates personalizing an electronic cord using a plurality of decorative cord identifiers.

FIGS. 5A-5G illustrate additional embodiments of cord identifiers.

FIGS. 6A-6C illustrate cord identifiers configured with alpha-numeric and other symbols.

FIG. 6D illustrates cord identifiers similar to FIGS. 6A-6C but further adapted to be attachable with each other.

FIG. 7 illustrates cord identifiers configured with alpha-numeric symbols or accessories.

FIG. 8 illustrates additional embodiments of cord identifiers.

### DETAILED DESCRIPTION OF THE PREFERRED EMBODIMENT

Customization of personal electronic products has become not only a way of recognizing one's personal belonging, but a way of establishing an image or reflection of one's personality and/or interests. There continues to be an increase of use and ownership of electronic products, including: mobile phones, smart phones, digital media players, handheld gaming devices, headphones, ear-buds and so forth. With each device there is generally provided a power cord and/or data cord unique to the particular device. Many of these devices allow for data input, data output or recharging of internal batteries. Electronic cords are provided to transfer power and/or data accordingly. With the increase of individuals owning electronic devices, or a plurality of devices, comes an increasing need to identify the cord associated with each particular device or the cord owned by a particular person. Confusion arises particularly in situations where individuals are using devices that utilize the same or similar cord, thus creating a need to identify cord ownership.

The present application seeks to provide a solution to the aforementioned problem by creating customizable and decorative cord identifiers configured to attach to electronic cords, whereby identifying the ownership of a particular cord is possible. The cord identifiers further create an external symbol indicative of, or associated with, the owner's loyalty to certain sports teams, stance on political issues, affiliation with a religious institution, profession, idea, philosophical viewpoint, cultural or ethnic backgrounds, groups, clubs or associations, and so forth. Additionally, the unique combination of cord identifiers can be used to support causes, show creativity, or any other expression desired.

Within the scope of the application is contemplated a business method of utilizing the decorative and personalizable aspects to raise money, and or awareness for a particular market. These steps may include, identifying a particular cause or purpose, identifying users of a particular device that tend to be supportive of the stated cause or purpose, developing a cord identifier customized to show support of the cause or purpose, and distributing the customized cord identification system to the identified group. An example of causes to raise money for could include cancer awareness or fundraising, introducing a new team or company, introduction of a new product, and fundraising for local schools or universities.

For purposes of this application, a detent may refer to any of a cavity, hole, channel, opening, slit, or other mechanism configured to temporarily keep a component in a certain position relative to that of another, and wherein the components may be released from each other by applying a force to one or both components. In addition, an identifier as described herein includes, but is not limited to, a device configured to attach to or receive, in at least one place, a portion of a cord, accessory, or another identifier. Cords defined herein include but are not limited to electronic cords, data transfer cords, non-electronic cords, necklaces, cord-like features, such as some linked chains.

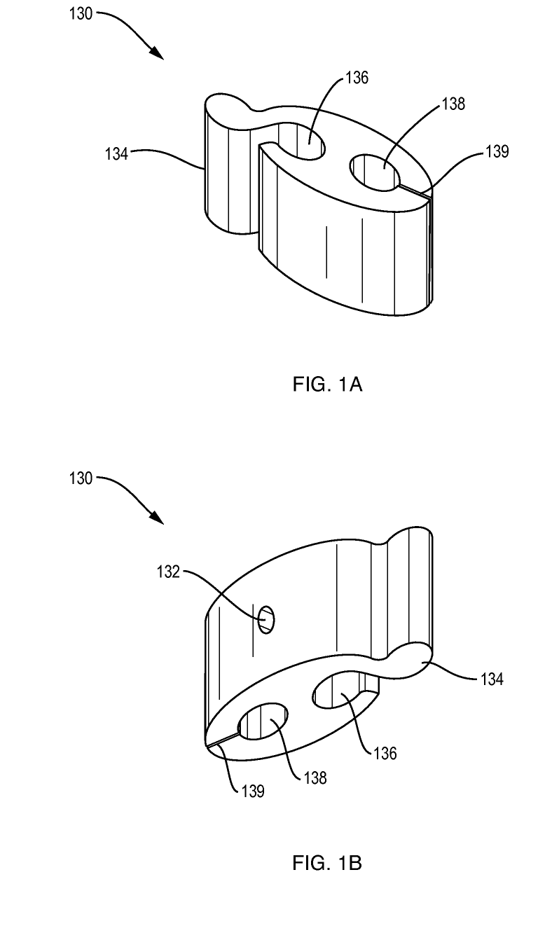

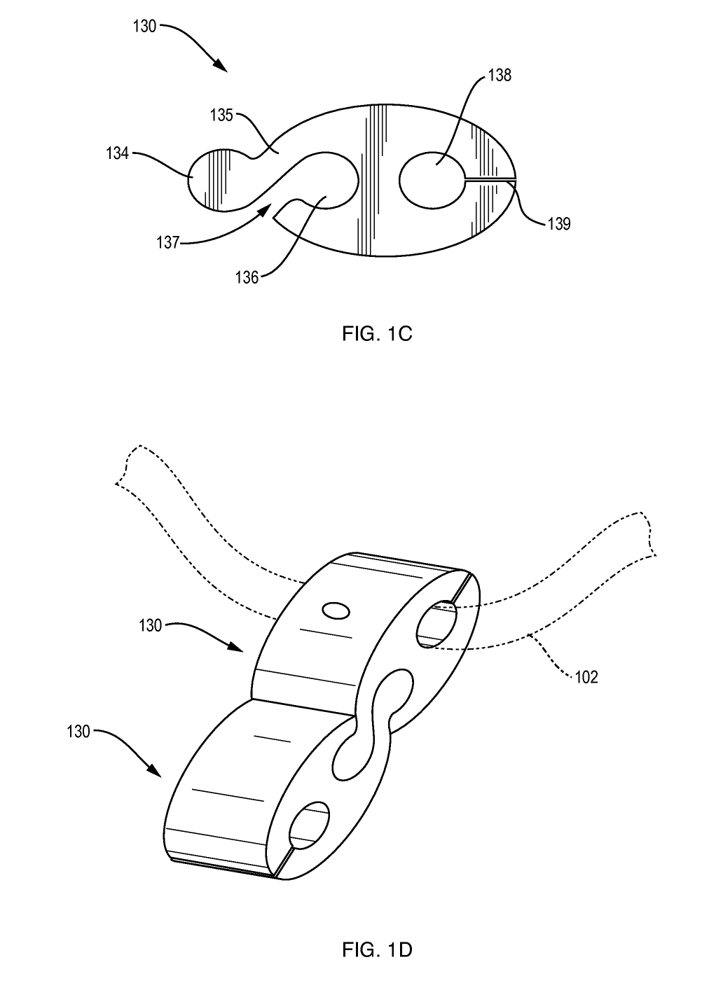

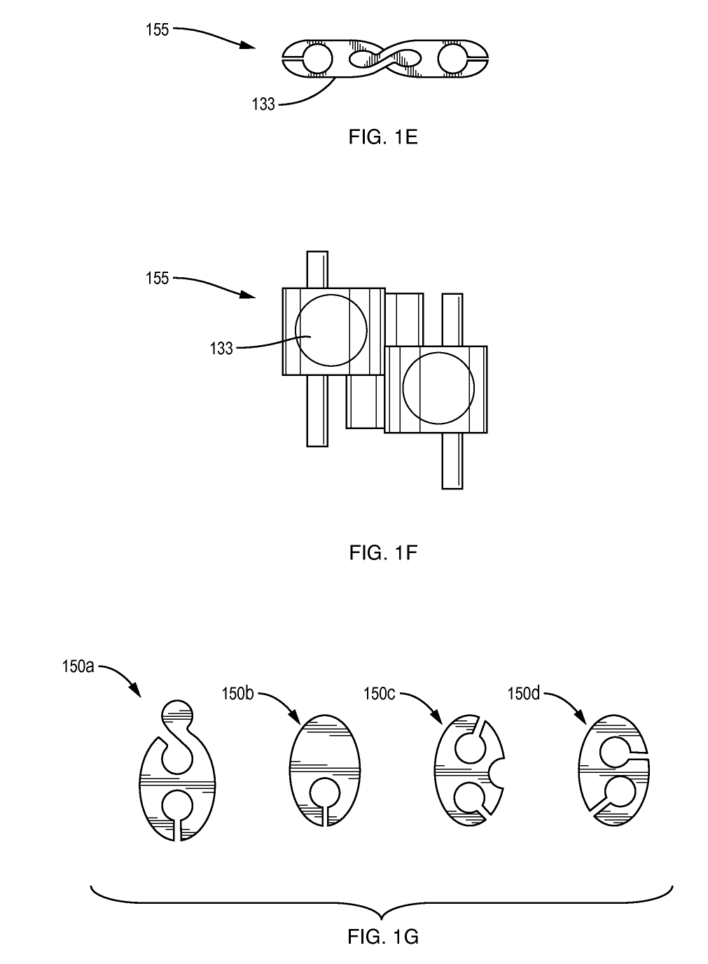

FIGS. 1A-1C, illustrate various views of an identifier 130 having multiple cavities or channels (136,138). The uni-body shape of identifier 130 has at least one detent 132 contained within an outer surface and configured to receive a post or other male-connector portion of a decorative accessory. A narrow slit 139 runs along one edge of identifier 130. This slit opens into a first cavity or channel 138 configured to partially encompass or encircle a cord 102. A second channel or cavity 136 is formed within an adjacent portion of the body and is configured to receive a second portion of a cord or alternatively slideably interlock with a protruding portion 134 extending from a second identifier 130 of similar shape. The second channel 137 allows for the cord to be press-fit into the channel and held by the deformable elastic nature of the identifier and/or elastic nature of a rubberized cord that has been press-fit into the channel. Channels 136 and 138 may align parallel to each other, and in some variations, channels 136 and 138 may be align perpendicular to each other.

FIG. 1D illustrates identifier 130 being used in a manner where two 130 identifiers are interlocked together. This interlocking is aided by a protruding portion 134 that fits within second channel 136. The interlocking configuration aides in bundling a cord together and keeping it organized. In some instances, looping the cord around an object may prevent the cord from sliding off the object. Looping can be accomplished by press-fitting two portions of the cord into the first and second cavities of a single identifier to complete a loop. A loop may also be created by interlocking two or more identifiers. In another configuration, identifier 130 may be used to create a necklace or bracelet out of a cord. Additionally, the core may be decorated with a decorative accessory attached to detent 132. FIGS. 1E-1F showadditional embodiments of the uni-body identifier depicted in FIGS. 1A-1D, however, in these embodiments, the identifier has a more level or flat surface on opposing sides, wherein surface portion 133 may be used to identify the cord. For instance, surface portion 133 may be configured to receive ink, stickers, or some other mark-able material to identify a person, cause, symbol and so forth.

FIG. 1G illustrates multiple identifier embodiments having one or more slots or channels having an oval-shaped side-view. For example, identifier 150a has narrow slit (not labeled) that runs along one of its edges. The slit opens into a first cavity or channel (as shown) configured to partially encompass or encircle a cord. A second channel or cavity may be formed within an adjacent portion of the body and is configured to receive a portion of a cord or alternatively, it may slideably interlock or press-fit with a protruding portion extending from a second identifier of similar shape. In other embodiments that an oval-shaped side-view, it is contemplated that there be only one cavity or channel, as demonstrated by identifier 150b. Also consistent with the present disclosure are identifiers 150c and 150d, each having an oval-shaped body and have a first narrow slit opening into a first cavity or channel and a second narrow slit opening into a second cavity or channel, the cavities or channels each being configured to receive a cord. Identifier 150c also having a detent. As demonstrated by identifiers 150c and 150d, the first channel and the second channel may align in a symmetrical manner across an axis, the channels may be parallel or perpendicular to each other, or the direction of the channels may not have a defined relationship with respect to each other.

As mentioned, identifier 130 has at least one detent 132 contained within at least an outer surface. In the embodiments shown in FIGS. 1A-1D, a detent is positioned on one side of the identifier. In other variations, it is contemplated that a detent be positioned on an opposing surface, side, or any other surface. Likewise, multiple detents may be placed on each side or surface of the identifier including some that extend from the main body portion of the identifier. In the case of multiple detents, it is contemplated that the detents may be placed a specified distance from each other or in a specified orientation. It is also contemplated that the detents may be angled with respect to one another.

It is also contemplated that a detent may be placed in a lobe or other protrusion extending from the body of an identifier. For example, an identifier with a cube-like base has a lobe, half-circle, or other protrusion extending from the base with a detent positioned within the inner portion of the lobe or half-circle (not shown). In another example, multiple lobes or protrusions may extend from the body or base of a single identifier.

The detents or holes may receive a decorative accessory through applying a force to a portion of the receiving member or interlocking a portion of the decorative accessory. For example, the detent may be a hole, wherein the male-portion of a decorative accessory is pressed into the detent. In other embodiments, the detent may have a ridge, wherein the male-portion of a decorative accessory is snapped into the detent. In yet another embodiment, the detent may be threaded, and thus, the male-portion of a decorative accessory is rotatably connected to the detent through a turning motion.

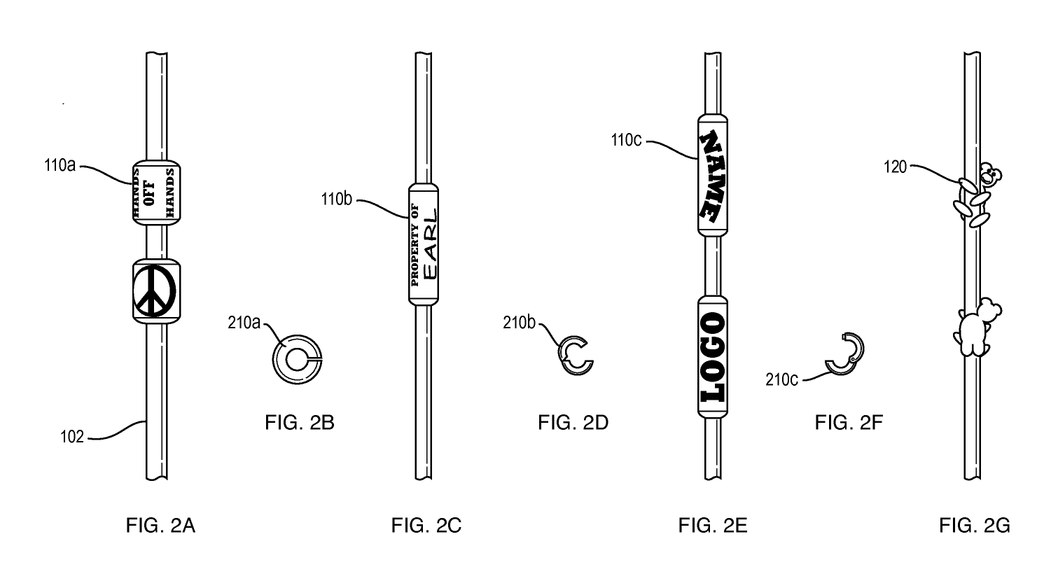

FIGS. 2A-2D illustrate samples of cord identifier embodiments, as well as exemplary ways to personalize one's electronic cord 102.

FIG. 2A illustrates one embodiment of a cord identifier, wherein the identifier 110a is shaped in a tube-like manner with an opening or slit along an edge, such that the tube may be configured to wrap around a cord 102. As shown in FIG. 2B, end views 210a of identifier 110a show a slit or opening (not labeled) that may be spread apart. FIG. 2C illustrates another embodiment, wherein the identifier 110b is shaped in an elongated tube-like manner. End view 210b of identifier 110b, as shown in FIG. 2D, illustrates a single slit from the center of 110b to the outer edge and a partial slit from the center that does not extend fully to the outer edge on the opposite internal side of 110b. The additional partial slit allows for the slit portion to open with less force when the identifier tube is opened to wrap around a cord 102. FIG. 2E illustrates an identifier 110c which is shaped in an elongated tube-like manner having an end view 210c, shown in FIG. 2F, wherein the identifier is hinged at one point about which the two arms pivot. In this embodiment a male protruding portion on the end of one of the arms may clasp or connected with a cavity or detent portion on the opposing arm allowing for 102c to be wrapped around cord 102 and snapped into place. In other embodiments, not shown, the slit or opening of the tubes as shown in FIGS. 2A-2F may form prongs that conform to the diameter or shape of the particular cord. FIG. 2G illustrates an identifier 120 having prongs that conform to the diameter of a cord.

FIGS. 2A-2F further demonstrate multiple embodiments of how an identifier can be personalized. For example, FIGS. 2A-2F may include a person's name, a web-address, a company name or logo, symbol, picture, phrase, or the like. Additionally, the prongs of identifiers 120 in FIG. 2G are configured to illustrate caricatures of animals' appendages, such as the arms and legs of a frog or bear.

The material of the identifiers shown in FIGS. 2A-2G may be elastically deformable such that identifier 110a, 110b, 110c, and/or 120 can be deformed, bent or reshaped momentarily to enlarge the slot for a portion of the cord to be inserted into the channel portion of the tube, after which, the slot elastically returns/retracts to its original form. The side view of each of embodiment illustrates various deformable or hinged identifiers. For example, 210a shows a single slit that can be spread open; 210b illustrates single slit with a partial slit on the opposite internal surface allowing for slit portion to open with less force; and 210c illustrates a hinged/pinned cross-section which two sections of the tube-like identifier may rotate about. Thus materials may include: rubber, plastic, silicone, or any other material demonstrating the desired properties mentioned above. Once a cord is inserted and the opening of the slot is released the identifier returns to its original shape. Alternatively, as mentioned above, some identifiers, such as 210c, may be hinged about a pin wherein elastic deformation is not required.

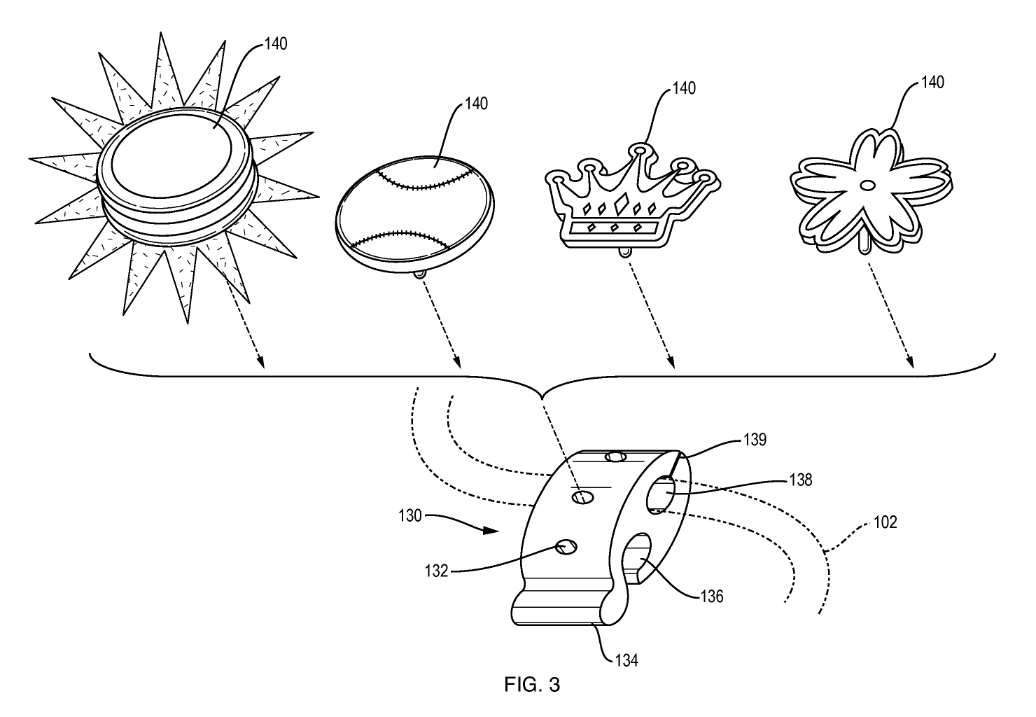

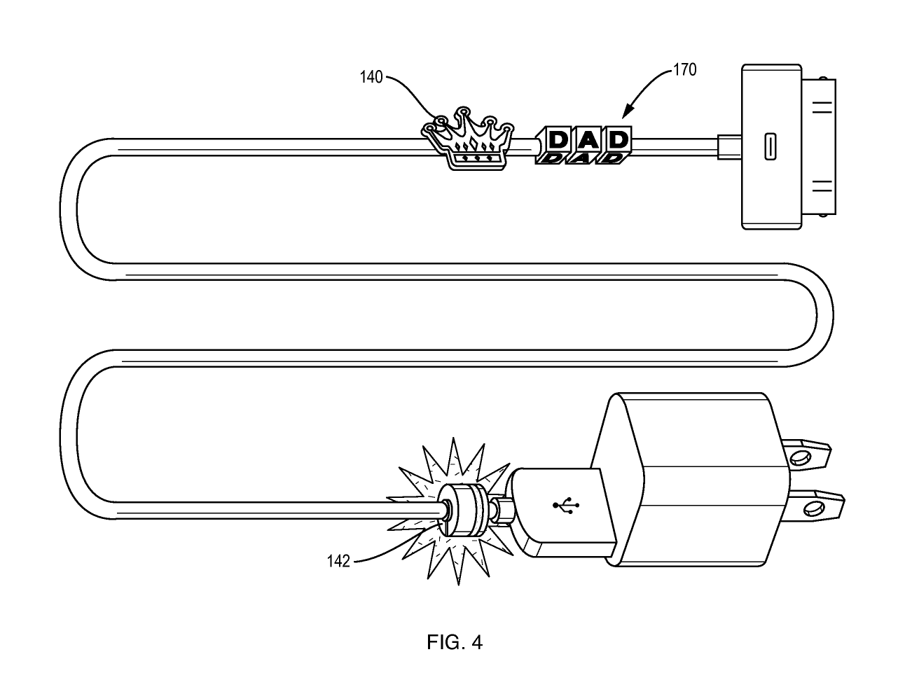

In other embodiments, such as those shown in FIG. 3, a plurality of detents 132 or holes may be included on 130 to receive additional decorative accessories 140. These decorative accessories 140 may include shapes of baseballs, flowers, crowns or other ornamental design desired. It may also be a holder to attach an LED light for use in the dark when trying to plug in the particular cord or for other practical purposes for having an LED light attached to the cord.

Some embodiments, not shown, contemplate embedding a chip within the identifier to be used with the GPS, or other radio embedded technology of an electronic portable device, to send and receive a signal in order to find the lost or misplaced cord. For instance, an owner may locate the cord receiver using a software application on their smart phone that tells them how close they are to the cord. Other applications contemplated include those sending a signal to the chip embedded in an identifier along with other electronic components such as a capacitor or battery and a light or speaker. The signal can then cause the cord to beep or light up. The software application may also be designed to automatically have the cord light up or beep when the portable electronic device has gone outside a particular range, or on the other side, the software application of the portable device may alert the owner that the cord has gone out of range. This may help remind owners to not leave their particulars cords behind when traveling.

FIG. 4 is illustrative of the mix and matching of a variety of cord identifiers to create an array of identifiers indicating ownership by a particular person.

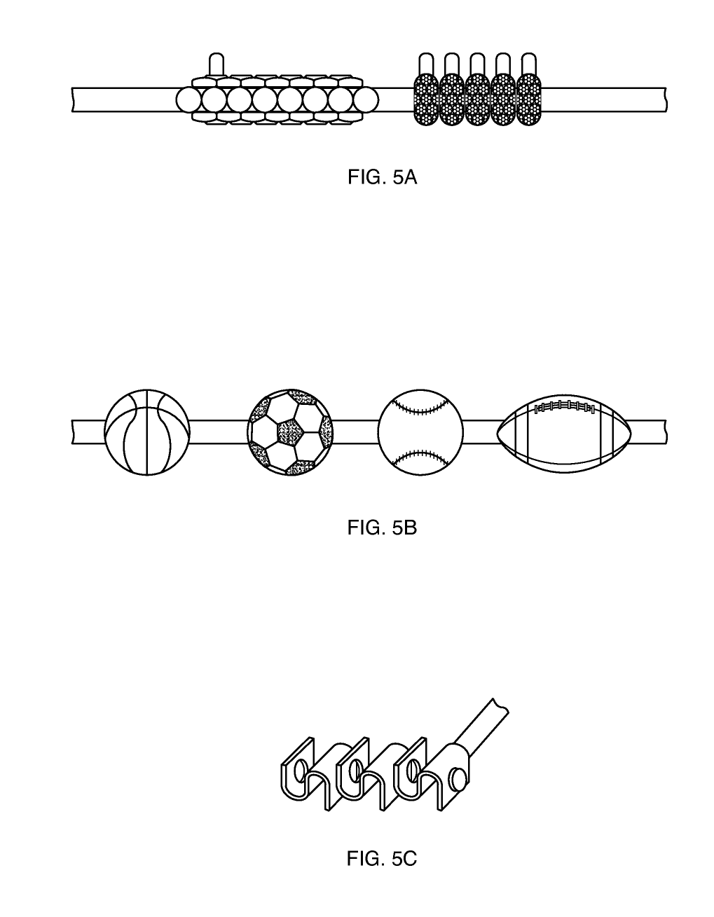

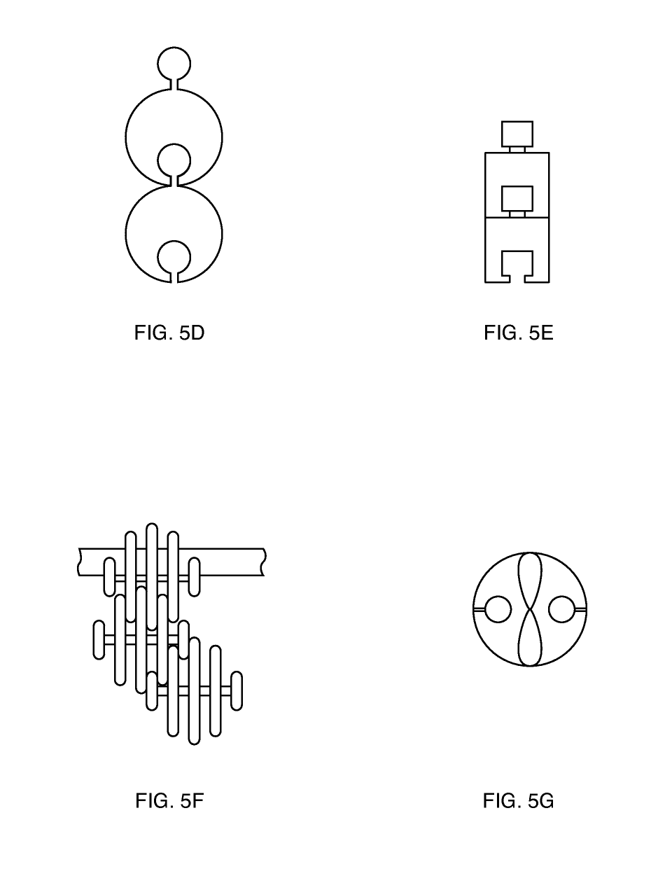

FIGS. 5A-5C illustrate other contemplated designs configure to have at least two channels for receiving at least two portions of a cord or in some cases portions of two different cords. FIG. 5A illustrates slightly transparent and gem-like structures where one channel encircles the cord more fully and act as a more permanent fixture while the second channel has a wider slot more conducive for press-fitting the cord in and out repeatedly. This may be helpful when bundling and unbundling a cord.

FIG. 5B shows a variety of sport-shaped identifiers with two-internal channels. Access to the internal channels is achieved through the same opening in the sidewall of the identifiers.

FIG. 5C illustrates channels adjacent with access to each channel on opposite sides. These particular identifiers further include protruding male components and female detents or holes configured to be connected with each other.

FIGS. 5D-5E show additional shapes contemplated in the present disclosure, the additional shapes having male-female connection points. For example, FIG. 5D has a male connection point having a similar size and shape as that of a cord. Thus, the female connection port can either accept a cord or the male connection point of a similar shaped identifier. FIG. 5E illustrates an embodiment similar to that shown in FIG. 5D, however, the male and female connection points are configured in a square/rectangular shape.

Additional two-channel cord identifiers are illustrated in FIGS. 5F-5G, more specifically, FIG. 5F uses honey comb shape to connect with other honey-comb shaped cord identifiers, while FIG. 5G illustrates a 3-dimensional shape configured to attach to at least one a cord.

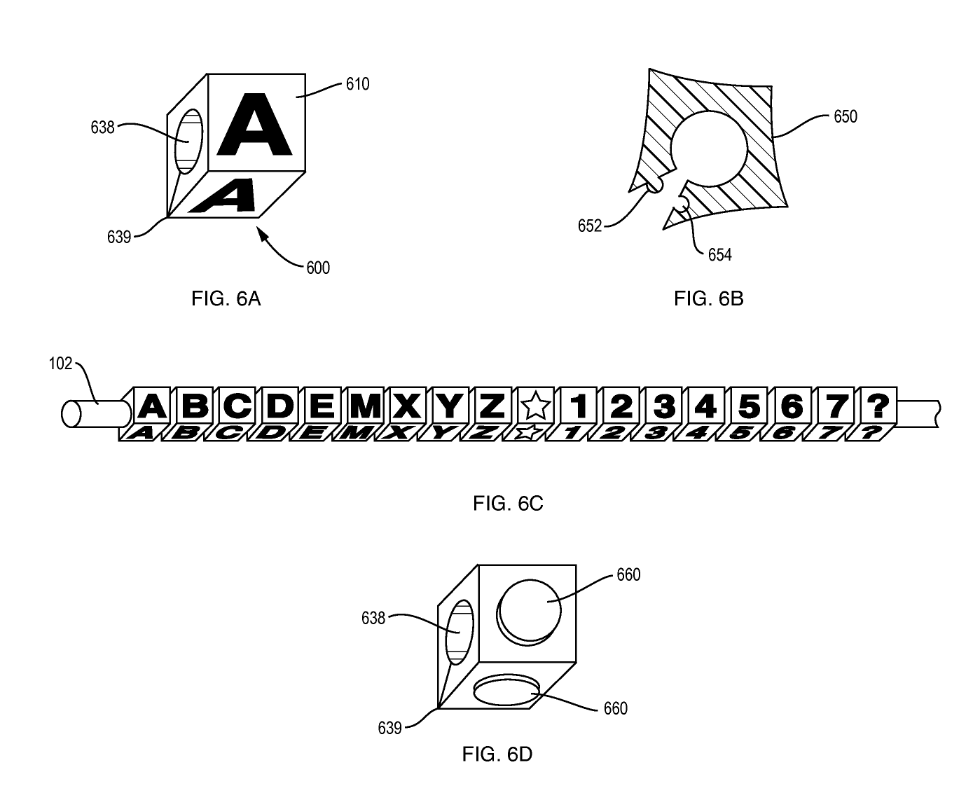

FIGS. 6A-6D illustrate block-shaped cord identifiers with flat edges configured to be marked by alpha-numeric and other symbols. In FIG. 6A, block 600 has a slit 639 from the corner of the block into the channel 638. Additionally, block 600 has an alpha-numeric character 610 on each side.

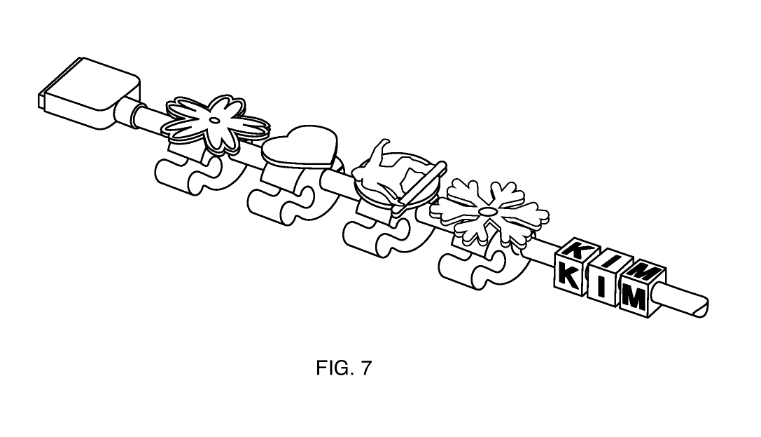

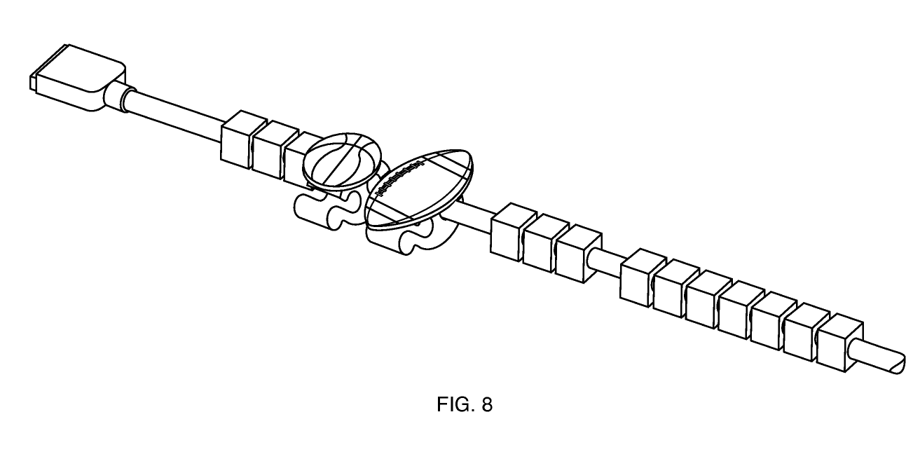

A cross-sectional elastically deformed view of identifier 650 is shown in FIG. 6B. Similar to block 600 in FIG. 6A, 650 has a slit from the corner of the block into the channel or opening of the block with the slot having a male connection point 652 and a female connection point 654 to secure the block identifier 650 when clasping or wrapping around a cord. FIG. 6C is an exemplary embodiment of how a cord owner might assemble letters on cord 102. Compiling individual letters allows the cord owner to spell their name or write-out their telephone number. As with most of the cord identifiers described herein, the identifiers are capable of being customized by color, shape, design, logo, letters, fonts, and any other indicia sought for. FIG. 6D shows a block identifier having a slit 639 from the corner of the block into the channel 638, the identifier also shows protruding points 660 on orthogonal sides. Not shown are detents or holes on opposite sides of each protruding portion. Again, designed to snap or press together, which may aide in bundling and organizing a cord(s). FIGS. 7-8 illustrate examples of how a cord may look with multiple identifiers attached thereto. Shown in both FIGS. 7-8 are uni-body identifiers with decorative accessories attached thereon as well as block-shaped identifiers, including block-shaped identifiers having alpha-numeric symbols.

Many of the embodiments shown employ a uni-body design, though it should not be construed that the invention is limited to such a design. However, the uni-body design allows for certain manufacturing advantage as well as simplicity when attaching to a cord.

While several embodiments have been described herein that are exemplary of the present invention, one skilled in the art will recognize additional embodiments within the spirit and scope of the invention.

What is claimed is:

1. A cord-identification system comprising:
a body having a first detent comprised of a channel formed in the body and a slit extending from the channel to an outer surface of the body, and wherein the body contains a second detent formed on the outer surface of the body, wherein the second detent is configured to receive a decorative accessory.

2. The cord-identification system of claim 1, further including a third detent formed of two protruding members extending from the body wherein a cavity is formed in between the protruding members.

3. The cord-identification system of claim 2, wherein one of the protruding members extends beyond the other protruding member, wherein the extended protruding member is configured to interlock with an extending protruding member and cavity of a similar-shaped cord identification system.

4. The cord-identification system of claim 2, wherein the cavity portion is configured to receive a portion of a cord.

5. The cord-identification system of claim 1, further including a third detent formed on the outer surface and configured to receive a decorative accessory.

6. The cord-identification system of claim 1, wherein the second detent is comprised of a cavity formed in the body and having an opening at the outer surface, wherein the opening contains a ridge portion configured to secure with a male-connector attachment portion of a decorative accessory.

7. The cord-identification system of claim 1, wherein the second detent is comprised of a cavity formed in the body and having an opening at the outer surface, and wherein the cavity is threaded.

8. The cord-identification system of claim 1, wherein the decorative accessory may include an LED light.

9. The cord-identification system of claim 1, further includes a male-connector extending from the body that is configured to be received by a detent of another cord-identification system.

10. The cord-identification system of claim 1, wherein a portion of the body is elastically deformable.

11. The cord-identification system of claim 2, wherein the protruding members form the appendages of a caricature.

12. The cord-identification system of claim 1, wherein the outer surface is configured to receive an image.

13. A cord-identification method comprising the steps of:
attaching a cord identification system to a portion of a cord, wherein the identification system includes a body having a first detent comprised of a channel formed in the body and a slit extending from the channel to an outer surface of the body, and wherein the body contains a second detent formed on the outer surface of the body, wherein the second detent is configured to receive a decorative accessory.

14. The cord-identification system of claim 13, further including a third detent formed of two protruding members extending from the body wherein a cavity is formed in between the protruding members.

15. The cord-identification system of claim 14, wherein one of the protruding members extends beyond the other protruding member, wherein the extended protruding member is configured to interlock with an extending protruding member and cavity of a similar-shaped cord identification system.

16. The cord-identification method of claim 15, further including the steps of:
attaching a second cord identification system to another portion of the cord;
attaching the second cord identification system to the protruding member of the first cord identification system, wherein the second cord-identification system comprises a body having a first detent comprised of a channel formed in the body and a slit extending from the channel to an outer surface of the body, and wherein the body contains a second detent formed on the outer surface of the body, wherein the second detent is configured to receive a decorative accessory.

17. The cord-identification method of claim 16, wherein a necklace is formed.

18. A method for promotion comprising the steps of:
identifying a group of users utilizing a particular electronic device having at least one cord associated with said device;
customizing a cord identification system comprised of a body having a first detent comprised of a channel formed in the body and a slit extending from the channel to an outer surface of the body, wherein the channel is configured to attach to the associated cord, and
wherein the body contains a second detent formed on the outer surface of the body, wherein the second detent is configured to receive a decorative accessory, and
wherein the identification system demonstrates a visual reminder or association with a cause or product; and
distributing the cord identification systems to the identified group.

19. The method of claim 18, wherein the cord-identification system further includes a third detent formed of two protruding members extending from the body wherein a cavity is formed in between the protruding members.

20. The method of claim 19, wherein one of the protruding members of the cord-identification system extends beyond the other protruding member and is configured to interlock with an extending protruding member and cavity of a similar-shaped cord identification system.
